(19) United States
(12) Patent Application Publication
(10) Pub. No.: US 2026/0257470 A1
(43) Pub. Date: Sep. 3, 2026

(54) CORRECTION OF MISALIGNMENT OF NOZZLES OF AN INKJET PRINTER

(71) Applicant: SPGPrints B.V., Boxmeer (NL)

(72) Inventors: Petrus Leonardus Johannes Welten, Geleen (NL); Johannes Maria Van Den Heuvel, Uden (NL); Bastiaan Petrus Van Drunen, Heijen (NL)

(21) Appl. No.: 19/163,935

(22) PCT Filed: May 30, 2024
(86) PCT No.: PCT/EP2024/064922

§ 371 Date: Sep. 10, 2025

(30) Foreign Application Priority Data
Jun. 2, 2023 (NL) 2034977

(51) Int. Cl. B41J 2/045; B41J 2/21; B41J 29/393

(52) U.S. Cl. CPC B41J 2/04505; B41J 2/04558; B41J 2/04581; B41J 2/2139; B41J 2/2142; B41J 29/393; B41J 2029/3935

(57) ABSTRACT

A method of correcting misalignment of nozzles of a multi-colour inkjet printer for printing an image on a printing medium that is movable with respect to the inkjet printer in a conveying direction includes the steps of determining relative droplets positions ejected by each nozzle, determining relative nozzle deviations from the relative droplets positions and assigning correction factors to each of the nozzles of the printheads. The inkjet printer has a plurality of printheads having nozzles for each printing colour. The plurality of printheads is mounted in a matrix configuration.

### CROSS-REFERENCE TO RELATED APPLICATIONS

This application is the National Stage of International Application No. PCT/EP2024/064922, filed May 30, 2024, which claims the benefit of Netherlands Application No. 2034977, filed Jun. 2, 2023, the contents of which is incorporated by reference herein.

### FIELD OF THE INVENTION

The present invention relates to inkjet printing and concerns correction of nozzle performance in an inkjet printer. In particular, the present invention relates to a method and system for correction of misalignment of nozzles of printheads in a multi-colour inkjet printer, an inkjet printing method and a computer program for executing the nozzle misalignment correction method.

### BACKGROUND OF THE INVENTION

In a scanning inkjet printer the printheads mounted on print colour bars carry out a reciprocal scanning movement in the width direction of a non-moving printing medium, e.g. carried by a driven carriage, during which an image or a part thereof is printed on the printing medium. During a stroke of the printhead in the width direction a nozzle prints along a line in the width direction of the printing medium. Between subsequent strokes the printing medium is conveyed in the length direction in order to position it for the next stroke of the printhead. In a multi pass mode of a scanning printer an image part is printed on the printing medium during multiple reciprocating strokes wherein the printing medium is moved intermittently between strokes. In a single pass mode of a scanning printer the image part is printed during one stroke. The print colour bars, that have a motion in the scanning direction perpendicular to the conveyance direction of the printing medium, are considerably smaller than the maximum printing medium width.

In an inkjet printer of the stationary type the printheads are mounted on a frame, that is stationary with respect to the conveyed printing medium. The printheads of a printing colour cover at least the width of the printing medium to be printed. A nozzle of a printhead prints a line in the longitudinal direction of the printing medium parallel to the conveying direction. Typically the printing medium such as a web of textile temporarily adhered to the conveyor, is conveyed continuously.

In inkjet printing the quality of a printed image is dependent on a number of factors, among which is the performance of the nozzles. If a nozzle does not perform according to predetermined specifications, the image quality is deteriorated. Moreover, nozzles are subject to wear, thereby changing the performance thereof over time. Visual inspection and evaluation of a test image to identify deviations and establish corrections thereof is laborious, cumbersome and subjective as it depends on the skills and experience of the operator. Software correction for failing nozzles, correction for non-uniformity of grey levels and oversaturation by evaluation of a scanned test pattern, that has been printed on a dedicated test substrate, is known from WO2020239820A1 in the name of the present applicant.

Regarding image quality an appropriate alignment of the printheads and nozzles thereof, as well as timed control of firing the right nozzle at the right time also play an important role in the performance of the nozzles and the resulting image quality. Alignment by mechanical means is restricted to aligning the printhead as a whole.

EP2853399A1 has disclosed a printing apparatus of the stationary type for printing to a printing medium configured for correcting step shift as printing shift in a transportation direction of a print medium, and a method of correcting the step shift. The printing apparatus comprises a printer having at least two line heads spaced away in a transportation direction of the print medium. The line heads each have a plurality of recording modules with a train of recording devices (nozzles) arranged linearly in a width direction of the print medium. The printing apparatus also comprises a scanner configured for scanning an image printed with the printer to obtain a scanned image, a correcting-chart printing unit configured to cause a first line head of the printer to print a first correcting chart in a first line head printing area and cause the first line head to print the first correcting chart and causes a second line head to print a second correcting chart in a second line head printing area, away from the first line head printing area in the transportation direction; a scanned image collecting unit configured to operate the scanner to read the first line head printing area and the second line head printing area to collect a first scanned image and a second scanned image, respectively; a correction-data calculating device configured to calculate correction data; and an adjusting device configured to adjust a timing in accordance with the correction data upon printing with the printer. The correction-data calculating device regards a line figure in the first scanned image formed with one of the plurality of recording modules as a reference line figure, and determines a difference in the transportation direction between the reference line figure and a line figure formed with the other recording module as a reference head difference, determines a difference in the transportation direction between a first line figure and a second line figure of the second scanned image as an individual head difference, the first line figure being formed with the first line head and the second line figure being formed with the second line head, and sums up the reference head difference and the individual head difference to obtain a total for every recording module, the reference head difference being regarded as the correction data in the transportation direction for every recording module in the first line head, and the total being regarded as the correction data for every recording module in the second line head. In the embodiments disclosed the second line figure is printed by printing half the lines for each of the recording modules of the respective line heads allowing to obtain correction data for every recording module. Thus EP2853399A1 discloses assigning the same correction data to each of the nozzles in a printhead.

US2012/0044291A1 has disclosed a printing apparatus of the scanning type and a printing method allowing to print a high quality image, even in case of misalignment in mounted print heads and/or of print medium conveying errors, by using a time division driving method (block driving method). Nozzles are divided into a plurality of blocks, wherein the driving order for a block of a plurality of nozzles is changed in accordance with a displacement of the block to print on the same raster. Thus US2012/0044291A1 discloses assigning the same driving order (correction data) to each of the nozzles in a block.

Both EP2853399A1 and US2012/0044291A1 do not disclose, nor allow for a misalignment correction of individual nozzles.

### BACKGROUND OF THE INVENTION

Further improvement of the image quality can be achieved by applying corrections based on identification of nozzle misalignment to the nozzle control data resulting in corrected nozzle control data that can be used for controlling each nozzle in printing an image by the inkjet printer.

The present invention aims at providing an automatic nozzle misalignment correction method for each individual nozzle, thereby compensating deviations of the nozzle performance.

In particular the present invention has as an object to provide a nozzle misalignment correction method and system for each nozzle or group of nozzles for each printhead in a multi-colour inkjet printer, either of the scanning type or of the stationary type, in particular an automated method wherein the involvement of the operator is minimal.

Another object of the invention is to provide such a nozzle misalignment correction method and system for each nozzle or group of nozzles for each printhead and for each print direction in a scanning printer.

In a first aspect the invention relates to a method of correcting misalignment of nozzles of a multi-colour inkjet printer for printing an image on a printing medium that is movable with respect to the inkjet printer in a conveying direction (C), the inkjet printer having a plurality of printheads for each printing colour, the plurality of printheads being mounted in a matrix configuration of columns and rows, a printhead having an array of nozzles configured for ejecting ink droplets of a printing colour (Clr), wherein either the printheads of the same printing colour are arranged in a column of the matrix configuration extending in a direction parallel to the conveying direction (C) of the printing medium and the printheads for different printing colours are arranged in rows extending in a direction perpendicular to the conveying direction (C) on a carriage that can reciprocate in a scanning direction perpendicular to the conveying direction (C) of the printing medium, or the printheads for different printing colours are stationary arranged in a column of the matrix configuration extending in a direction parallel to the conveying direction (C) and the printheads for the same printing colour are arranged in rows extending in a direction perpendicular to the conveying direction (C);
wherein the method comprises the steps of.
a) determining relative positions of droplets, ejected by each of the nozzles of each of the printheads for a reference printing colour (Clr_ref) with respect to a reference element,
b) determining relative positions of droplets, ejected by each of the nozzles of each of the printheads for each of the printing colours (Clr≠Clr_ref) other than the reference printing colour (Clr_ref) with respect to relative positions of the droplets ejected by each of the nozzles of the corresponding printhead for the reference printing colour (Clr_ref),
c) determining deviations for each of the nozzles of each of the printheads based on the determined relative positions of the droplets, ejected by the nozzles of the printheads, and
d) assigning correction factors to each of the nozzles of each of the printheads of the plurality of printheads based on the determined deviations of the nozzles of the printheads.

In this method of the first aspect of the invention correction factors for misaligned nozzles are obtained for each nozzle of all printheads. The printheads are arranged in matrix configuration of columns in a direction parallel to the conveying direction of a printing medium, which columns represent either in an inkjet printer of the scanning type the printing colours, indicated by (Clr), or in an inkjet printer of the stationary type the printheads for different printing colours and rows, in the perpendicular direction, which rows represent either in an inkjet printer of the scanning type the number of printheads, indicated by number n, for a printing colour, or in an inkjet printer of the stationary type the printheads for the same printing colour. For sake of clarity and illustration purposes a position of a printhead in the matrix configuration of an inkjet printer of the scanning type is represented by (Clr, n), wherein Clr indicates the printing colour, and n indicates the number of the printhead in the column of printheads for colour Clr. A position of a printhead in the matrix configuration of an inkjet printer of the stationary type is represented by (n, Clr), wherein n indicates the column number of the printheads for printing colour Clr in the matrix configuration and Clr indicates the printing colour in a row of the matrix configuration of the printheads. Thus a particular printhead can be identified by its position. In the matrix configuration of an inkjet printer of the stationary type the printheads for a printing colour may be arranged in staggered configuration such that adjacent printheads partly overlap each other.

Typically the printing colours comprise at least black (K), cyan (C), magenta (M) and yellow (Y) and optionally one or more additional colours, e.g. blue (Bl) and orange (O). The number of printheads for a printing colour is not limited, but typically in the range of 4-12, such as 6 or 8, in an inkjet printer of the scanning type. As in an inkjet printer of the stationary type the printheads need to cover the width of the printing medium in industrial printers having a print width up to a few metres such as 1 to 2 metres, this number is larger, e.g. in the range of 30-60.

In a first step a) the relative positions of droplets ejected from each of the nozzles of each of the printheads of one of the printing colours, that is selected as the reference printing colour (Clr_ref), are determined with respect to a reference element, e.g. by applying an imaginary line such as a spline (mathematical function defined piecewise by polynomials) through an actual line printed by ejecting droplets from each of the nozzles of these printheads of the reference printing colour, and measuring the distance to a reference element, such as a desired (fixed) position thereof. Advantageously, black (K) is selected as the reference printing colour, as it is the most contrasting colour, the most predominant colour in an image and typically shows the most colour deviation.

In a second step b) relative positions of droplets ejected from each of the nozzles of the printheads of the printing colours (Clr≠Clr_ref) other than the reference printing colour (Clr_ref) are determined with respect to the droplets ejected by the nozzles of the corresponding printheads of the reference printing colour. In case of an inkjet printer of the scanning type generally the corresponding printhead of the reference printing colour (Clr_ref) is the printhead of the reference printing colour (Clr_ref) in the same row as the respective printhead of the printing colours (Clr≠Clr_ref) other than the reference printing colour (Clr_ref). In case of an inkjet printer of the stationary type generally the corresponding printhead of the reference printing colour (Clr_ref) is the printhead of the reference printing colour (Clr_ref) in the same column as the respective printhead of the printing colours (Clr≠Clr_ref) other than the reference printing colour (Clr_ref).

From the relative positions of the droplets thus determined deviations of each of the nozzles of all printheads are determined in step c) and converted into correction factors in step d) for each nozzle. Typically the correction factors are stored in a table of chart. Advantageously the correction factors are rounded to integers representing a translation of pixels, which can be used in corrected nozzle control data for a controller in actual printing of an image. The method according to the invention determines an individual correction factor for each of the nozzles of all printheads. Using corrected nozzle control data that take into account these correction factors individually determined for each of the nozzles by the method according to the invention in printing an image allows to improve the quality of the printed image compared to an image printed using uncorrected nozzle control data.

In an embodiment steps a)-b) comprise printing a test pattern on a test substrate, the test pattern comprising a test pattern section for each printhead, and scanning the printed test pattern, and determining the relative positions of droplets ejected by each of the nozzles of each printhead. In this embodiment a test pattern is designed that comprises a test pattern section for each printhead of each printing colour. Such a test pattern section comprises image elements, such as one or more lines, to be printed by the printhead of which the correction factors for each of the nozzles are to be determined, and reference image elements, such as one or more reference lines, to be printed by a printhead of the reference printing colour. In an embodiment a line to be printed by the printhead of a printing colour (Clr≠Clr_ref) other than the reference printing colour (Clr_ref) of which the correction factors for the nozzles are to be determined is positioned between lines to be printed by the corresponding printhead of the reference printing colour (Clr_ref) in order to eliminate effects from the test substrate itself, from the handling thereof and from the scanner. In this way the correction factors derived from the relative positions of the printing elements are substantially related only to the nozzles of the printheads of the inkjet printer. This test pattern is printed on a test substrate, typically a test substrate having a receiving layer adapted to the nature of inkjet ink, such as (reactive) dye ink, solvent based ink, water based ink. The test substrate thus printed with the test pattern is scanned and the scan is analysed for relative positions and deviations therefrom as outlined above to achieve individual correction factors for each of the nozzles, which are stored for use in corrected nozzle control data in actual printing.

In an embodiment of the method for an inkjet printer of the scanning type, wherein the printheads of the same printing colour are arranged in a column of the matrix configuration extending in a direction parallel to the conveying direction (C) and the printheads for different printing colours are arranged in rows extending in a direction perpendicular to the conveying direction (C) on a carriage that can reciprocate in a scanning direction (S) perpendicular to the conveying direction (C) of the printing medium, wherein a printhead position of a printhead in the matrix configuration is represented by (Clr, n), wherein Clr indicates the printing colour in a column of the matrix configuration of the printheads, and n indicates the row number of the printheads for colour Clr in the matrix configuration, step a) comprises the substeps of:
a1) determining relative positions of droplets, ejected by each of the nozzles of a reference printhead for a reference printing colour (Clr_ref) at printhead position (Clr_ref, r), with respect to a reference element,
a2) determining relative positions of droplets, ejected by each of the nozzles of the remaining printheads for the reference printing colour (Clr_ref) at printhead position (Clr_ref, n≠r) with respect to relative positions of droplets ejected by the nozzles of the reference printhead for the reference printing colour at printhead position (Clr_ref, r).

In this embodiment one printhead of one of the printing colours is selected as a basis on which the correction factors for the remaining printheads of the same printing colour and the correction factors for the printheads of the printing colours other than the reference printing colour depend directly or indirectly. This one printhead is indicated as the reference printhead and its position is (Clr_ref, r). The selected printing colour is referred to as the reference printing colour (Clr_ref). Advantageously, the reference printhead is the printhead of the reference printing colour that moves as the last (seen in the conveyance direction of the printing medium) one over the printing medium.

In substep a1) the positions of the droplets are determined with respect to a reference element, e.g. by applying an imaginary line such as a spline (mathematical function defined piecewise by polynomials) through an actual line printed by ejecting droplets from each of the nozzles of this reference printhead, and measuring the distance to a desired (fixed) position. In substep a2) relative positions of droplets, ejected from each of the nozzles of the remaining printheads of the reference printing colour at positions (Clr≠Clr_ref. n≠r) are determined with respect to this reference printhead. Thereby the nozzles of all printheads of the reference printing colour (Clr_ref), which can print on any position on a printing medium during a stroke of the reciprocating scanning movement, can be corrected such that a line can be properly addressed by the nozzles of all printheads of the reference printing colour (Clr_ref). Relative positions of droplets ejected from the nozzles of the printheads of the printing colours (Clr≠Clr_ref) other than the reference printing colour at positions (Clr≠Clr_ref, n) are determined with respect to the corresponding printhead of the reference printing colour in the same row n, i.e. comparing the printhead of the respective printing colour at position (Clr≠Clr_ref, n) to the printhead of the reference printing colour in the same row (n is equal) at position (Clr_ref, n).

In a further embodiment thereof printing the test pattern section for the reference printhead of reference printing colour (Clr_ref), typically black (K), comprises—during movement of the carriage in a first stroke of the scanning direction, e.g. forward movement from left to right—printing at least one line, preferably at least two, such as three spaced apart lines, by ejecting ink droplets from each of the nozzles of the reference printhead for the reference printing colour at position (Clr_ref, r). The reference printhead prints preferably three lines of the reference printing colour, which are used in the calculation of the individual nozzle deviations.

In an embodiment printing the test pattern section for each of the remaining printheads of reference colour (Clr_ref) comprises—during movement of the carriage in a first stroke of the scanning direction—printing at least one line, preferably at least two spaced apart lines by ejecting ink droplets from each of the nozzles of each of the remaining printheads of the reference printing colour at printhead positions (Clr_ref, n, wherein n r) and printing at least one reference line by ejecting ink droplets from each of the nozzles of the reference printhead for the reference printing colour at printhead position (Clr_ref, r). Advantageously, a reference line printed by the reference printhead at printhead position (Clr_ref, r) is printed between lines printed by the remaining printheads of the reference printing colour (Clr_ref), as the basic design (lines 1, 3 and 5 printed by the corresponding printhead of the reference colour in the first stroke) of this embodiment of the test pattern section is the same for all printheads. Alternatively, in an embodiment a line printed by the remaining printheads of the reference printing colour (Clr_ref) is printed between two reference lines printed by the reference printhead at printhead position (Clr_ref, r).

The relative positions of the lines printed by the respective remaining printhead with respect to a reference line printed by the reference printhead can be found by e.g. applying a spine function to the lines printed by the respective remaining printhead. Then calculation of the individual deviation of each of the nozzles of the remaining printheads of the reference printing colour with respect to the reference printhead can be done using the equation ((Actual Position Line 1+Actual Position Line 3)/2)−Actual Position Reference Line 2, wherein Actual Position Line 1 and Actual Position Line 3 indicate the positions of the two lines printed by the remaining printhead at position (Clr_ref, n≠r) and Actual Position Reference Line 2 indicates the position of the reference line printed by the reference printhead at position (Clr_ref, r). Thus the equation presents a distance between the actual position and the reference position for each nozzle. A deviation for a nozzle of a remaining printhead is increased with the deviations calculated for the reference head nozzle of the reference printing colour, because the position of the remaining printheads, and thus the nozzles thereof, of the reference printing colour is relative to that of the reference head of the reference printing colour.

In an embodiment printing the test pattern section for each of the printing colours (Clr≠Clr_ref) other than the reference printing colour (Clr_ref) comprises—during movement of the carriage in a first stroke of the scanning direction—printing at least one line by ejecting ink droplets from each of the nozzles of each of the printheads of the printing colours at printhead positions (Clr, wherein Clr≠Clr_ref, n) and printing at least one reference line, preferably two spaced apart reference lines by ejecting ink droplets from each of the nozzles of the corresponding printhead for the reference printing colour (Clr_ref) at printhead position (Clr_ref, n) having the same n. Advantageously the line printed by the printhead of which the relative position is to be determined is printed between the two reference lines. Then the deviations can be calculated from the relative positions, which have been found by applying e.g. a spline function, using the equation Actual Position Line 2−((Actual Position Reference Line 1+Actual Position Reference Line 3)/2), wherein Actual Position Reference Line 1 and Actual Position Reference Line 3 indicate the positions of the two lines printed by the printhead at position (Clr_ref, n) and Actual Position Line 2 indicates the position of the line printed by the remaining printhead (Clr/Clr_ref, n). To the distance thus determined the deviation of the printhead nozzles of the reference printing colour at position (Clr_ref, n) is added, because the position is determined relative to the printhead nozzles of the reference printing colour at this position (Clr_ref, n).

As the function of the nozzles in a first stroke (e.g. forward) of the scanning direction may differ from that in the second (opposite) stroke (e.g. backward) of the carriage of an inkjet printer of the bidirectional scanning type, in an embodiment thereof printing of the test pattern further comprises—during movement of the carriage in a second stroke in the scanning direction opposite to the first stroke printing at least one line for each printing colour by ejecting droplets from each of the nozzles of each printhead of the plurality of printheads, further comprising determining relative positions of the droplets ejected by each of the nozzles of each of the printheads for each of the printing colours at position (Clr, n) during movement of the carriage in the second stroke in the scanning direction opposite to the first stroke, with respect to relative positions of the droplets ejected by each of the nozzles of the corresponding printhead for the reference printing colour (Clr_ref) at printhead position (Clr_ref, n) having the same n during the movement of the carriage in the first stroke of the scanning direction, determining deviations for each of the nozzles of each of the printheads based on the determined relative positions of the droplets, ejected by each of the nozzles of the printheads, and assigning correction factors for printing in the first stroke and for printing in the second stroke to each of the nozzles of the printheads of the plurality of printheads based on the determined relative positions of the nozzles of the printheads. By adding a line to be printed in the second (backward) stroke to the test pattern section for each printhead of the plurality of printheads, printing thereof on a test substrate, scanning the test substrate having the printed test pattern and analysing the scan also correction factors for each nozzle for printing in the backward stroke can be achieved in addition to those for the forward stroke. Advantageously, the line to be printed in the second stroke is positioned in between lines to be printed by the same printhead in the first stroke. E.g., in the above embodiments about the test pattern sections to be printed in the forward stroke, a fourth line to be printed in the backward stroke, and a fifth line also to be printed in the forward stroke are added, such that the fourth line to be printed in the backward stroke will be printed in between two lines printed in the forward stroke by the printhead of the reference printing colour at position (Clr_ref, n).

In particular, for the remaining printheads of the reference printing colour the relative deviations for each nozzle in the backward stroke can be calculated from the relative positions using the equation Actual Position Line 4 Backward−((Actual Position Line 3+Actual Position Line 5)/2), wherein Actual Position Line 4 Backward indicates the position of the line printed in the backward stroke and Actual Position Line 3 and Actual Position Line 5 indicate the positions of the two neighbouring lines printed by the printhead of the reference printing colour in the forward stroke. To the distance thus determined for the backward stroke the nozzle deviation determined for the forward stroke is added.

Similarly, the relative nozzle deviations for the other printing colours in the backward stroke can be calculated from the relative positions using the equation Actual Position Line 4 Backward−((Actual Position Line 3+Actual Position Line 5)/2) wherein Actual Position Line 4 Backward indicates the position of the line printed in the backward stroke by the printhead at position (Clr≠Clr_ref, n) and Actual Position Line 3 and Actual Position Line 5 indicate the positions of the two neighbouring lines printed by the printhead of the reference printing colour at position (Clr_ref, n) for the same n in the forward stroke.

Thus from the relative positions the individual deviations for each of the nozzles in the backward stroke can be calculated using e.g. a spline function. To a nozzle deviation in the backward stroke the nozzle deviation for the reference colour in the forward stroke is added, as the position in the backward stroke is determined relative to the position in the forward stroke.

All deviations for each of the nozzles in the printhead of the reference printing colour in the forward stroke are advantageously stored, because these are used as references in determining the individual nozzle deviations for all other printing colours in both the first direction (forward stroke) and the second direction opposite to the first direction (backward stroke).

In an embodiment of the nozzle misalignment correction method for an inkjet printer of the stationary type the printheads for different printing colours are stationary arranged in a column of the matrix configuration extending in a direction parallel to the conveying direction (C) and the printheads for the same printing colour are arranged in rows extending in a direction perpendicular to the conveying direction (C); wherein a printhead position of a printhead in the matrix configuration is represented by (n, Clr), wherein n indicates the column number of the printheads for printing colour Clr in the matrix configuration and Clr indicates the printing colour in a row of the matrix configuration of the printheads;
wherein step a) comprises:
determining relative positions of droplets, ejected by each of the nozzles of each of the printheads for a reference printing colour (Clr_ref) at position (n, Clr_ref) with respect to a reference element. In an inkjet printer of the stationary type the printheads of a certain printing colour are arranged next to one another in the width direction of the printing medium and print along lines parallel to the conveying direction of the printing medium. Thus a given position in an image to be printed can be addressed by one nozzle or group of nozzles of one printhead of each printing colour, contrary to an inkjet printer of the scanning type. Therefore in step a) the relative positions of droplets, ejected by each of the nozzles of each of the printheads for a reference printing colour (Clr_ref) at position (n, Clr_ref) are determined with respect to a reference element, e.g. by applying an imaginary line such as a spline (mathematical function defined piecewise by polynomials) through an actual line printed by the nozzles of these printheads of the reference printing colour, and measuring the distance to a reference element, such as a desired (fixed) position thereof. Each of these printheads of the reference printing colour acts as a corresponding printhead in step b) for the printheads of the other printing colours (Clr≠Clr_ref). Steps b)-d) are performed as outlined above.

In an embodiment printing of the test pattern sections for the printheads of each printing colour at printhead position (n, Clr), wherein n is the same for each printing colour, comprises printing spaced apart at least one line of each printing colour (Clr≠Clr_ref) other than the reference printing colour (Clr_ref) by ejecting droplets from each of the nozzles of the respective printhead, from which line the relative positions of the droplets are determined, and printing at least one line of the reference printing colour (Clr_ref) between the at least one line of each printing colour (Clr≠Clr_ref) other than the reference printing colour (Clr_ref), and advantageously also at least one line of the reference printing colour (Clr_ref) in front of the first line of the first printed printing colour (Clr≠Clr_ref) other than the reference printing colour (Clr_ref) and at least one line of the reference printing colour (Clr_ref) at the rear of the last line of the last printed printing colour (Clr≠Clr_ref) other than the reference printing colour (Clr_ref).

In an embodiment thereof the test pattern may comprise a number of lines to be printed by ejecting droplets from each of the nozzles of a printhead of the reference printing colour at position (n, Clr_ref), which number is at least equal to the number of printing colours plus 1, and at least one line to be printed by ejecting droplets from each of the nozzles of each printhead of a printing colour other than the reference printing colour at position (n, Clr Clr_ref) at the same n for each other colour between two adjacent lines to be printed by the nozzles of a printhead of the reference printing colour at position (n, Clr_ref). In this case a line of the reference printing colour may be used in the determination of the relative positions of two other printing colours. Such a test pattern is relatively simple in design.

In step d) the total deviations thus determined are converted into individual nozzle corrections factors e.g. by multiplying with a factor*−1 (the correction factor to be applied is the opposite of the determined deviation) and rounded to an integer, because only pixels in the images to be printed using these correction factors in corrected nozzle control data can be addressed. Thus the integers represent a translation in pixels.

The thus determined correction factors apply to a given speed of the inkjet printer in the scanning direction. If the inkjet printer is also configured for printing at a different speed, then the correction factors thus assigned have to be adapted to the different speed. E.g. if the original correction factors are determined at a normal speed, such as 1200 dpi, then for a speed twice as fast, of 600 dpi, the correction factors are adjusted by dividing by 2.

In a second aspect the invention relates to a system for correcting misalignment of nozzles of a multi-colour inkjet printer for printing an image on a printing medium that is movable with respect to the inkjet printer (12) in a conveying direction (C), comprising
an inkjet printer having a plurality of printheads for each printing colour, the plurality of printheads being mounted in a matrix configuration of columns and rows, a printhead having an array of nozzles configured for ejecting ink droplets of the a printing colour, wherein either the printheads of the same printing colour are arranged in a column of the matrix configuration extending in a direction parallel to the conveying direction, and the printheads for different printing colours are arranged in rows in the scanning direction; wherein a position of a printhead in the matrix configuration is represented by (Clr, n) wherein Clr indicates the printing colour, and n indicates the row number of the printhead for colour Clr in the matrix configuration, or the printheads for different printing colours are stationary arranged in a column of the matrix configuration extending in a direction parallel to the conveying direction (C) and the printheads for the same printing colour are arranged in rows extending in a direction perpendicular to the conveying direction (C), wherein a printhead position of a printhead in the matrix configuration is represented by (n, Clr), wherein n indicates the column number of the printheads for printing colour Clr in the matrix configuration and Clr indicates the printing colour in a row of the matrix configuration of the printheads, the inkjet printer being provided with a controller configured for controlling the nozzles of the plurality of inkjet printheads;
a scanner for scanning a test pattern printed by the inkjet printer;
a computer configured to correct misalignment of nozzles of the plurality of printheads of the inkjet printer according to the method of the invention according to the above first aspect resulting in corrected nozzle control data for the controller, based on the assigned correction factors.

This system comprising an inkjet printer, scanner, computer and controller offers the same advantages as the nozzle misalignment correction method of the first aspect of the invention. The embodiments of the method are equally applicable to this system of the second aspect of the invention.

In an embodiment the controller is configured for printing a test pattern on a test substrate, the test pattern comprising a test pattern section for each printhead, the scanner is configured for scanning the test pattern printed on the test substrate, the computer is configured for assessing the relative positions of droplets ejected by each of the nozzles of each printhead in a scan of the test pattern printed on the test substrate and determining relative deviations from the relative positions thus determined for each nozzle of all printheads, and assigning correction factors to each of the nozzles of each printhead and storing the correction factors.

In a further embodiment of the system the controller is configured for printing a line of a printing colour other than the reference printing colour, from which line the relative positions of the droplets are determined, spaced apart between lines of the reference printing colour.

In an embodiment the system also comprises a substrate having a receiving layer adapted to the nature of the inkjet ink.

In an embodiment the system also comprises a memory readable by the controller and configured for storing the correction factors of each nozzle of the plurality of printheads.

In an embodiment the controller is configured to print a test pattern on the test substrate, by jetting inkjet ink from an inkjet printhead of the inkjet printer and configured to print an image on a printing medium by jetting inkjet ink from an inkjet printhead of the inkjet printer using the corrected nozzle control data derived from the correction factors.

In an embodiment, wherein the system comprises an inkjet printer of the scanning type, wherein the printheads are mounted on a carriage that can reciprocate in a scanning direction perpendicular to the conveying direction of the printing medium, the computer is configured for
a1) determining relative positions of droplets, ejected by each of the nozzles of a reference printhead for a reference printing colour (Clr_ref) at printhead position (Clr_ref, r), with respect to a reference element,
a2) determining relative positions of droplets, ejected by each of the nozzles of the remaining printheads for the reference printing colour (Clr_ref) at printhead position (Clr_ref, n r) with respect to relative positions of droplets ejected by the nozzles of the reference printhead for the reference printing colour at printhead position (Clr_ref, r),
b) determining relative positions of droplets, ejected by each of the nozzles of each of the printheads for each of the printing colours (Clr≠Clr_ref) other than the reference printing colour (Clr_ref) at printhead position (Clr≠Clr_ref, n) with respect to relative positions of the droplets ejected by the nozzles of the corresponding printhead for the reference printing colour (Clr_ref) at printhead position (Clr_ref, n) having the same n,
c) determining deviations for each of the nozzles of each of the printheads based on the determined relative positions of the droplets, ejected by each of the nozzles of the printheads, and
d) assigning correction factors to each of the nozzles of the printheads of the plurality of printheads based on the determined deviations of each of the nozzles of the printheads.

In a further embodiment thereof the controller is configured for
printing the test pattern section for the reference printhead of reference printing colour (Clr_ref) comprising during movement of the carriage in a first stroke of the scanning direction printing at least one line, preferably at least two, such as three spaced apart lines by ejecting ink droplets from each of the nozzles of the reference printhead for the reference printing colour at position (Clr_ref, r); and/or
printing the test pattern section for each of the remaining printheads of reference colour (Clr_ref) comprising during movement of the carriage in a first stroke of the scanning direction printing at least one line, preferably at least two spaced apart lines by ejecting ink droplets from each of the nozzles of each of the remaining printheads of the reference printing colour at printhead positions (Clr_ref, n≠r) and printing at least one reference line by ejecting ink droplets from each of the nozzles of the reference printhead for the reference printing colour at printhead position (Clr_ref, r); and/or
printing the test pattern section for each of the printing colours (Clr≠Clr_ref) other than the reference printing colour (Clr_ref) comprising during movement of the carriage in a first stroke of the scanning direction printing at least one line by ejecting ink droplets from each of the nozzles of each of the printheads of the printing colours at printhead positions (Clr≠Clr_ref, n) and printing at least one reference line, preferably at least two reference lines spaced apart by ejecting ink droplets from each of the nozzles of the corresponding printhead for the reference printing colour (Clr_ref) at printhead position (Clr_ref, n) having the same n.

Additionally for an inkjet printer of the bidirectional scanning type, the controller is configured for printing of the test pattern further comprising during movement of the carriage in a second stroke in the scanning direction opposite to the first stroke printing at least one line for each printing colour by ejecting droplets from each of the nozzles of each printhead of the plurality of printheads, further comprising determining relative positions of the droplets ejected by each of the nozzles of each of the printheads for each of the printing colours at position (Clr, n) during movement of the carriage in a second stroke in the scanning direction opposite to the first stroke, with respect to relative positions of the droplets ejected by the nozzles of the corresponding print head for the reference printing colour (Clr_ref) at printhead position (Clr_ref, n) having the same n during the movement of the carriage in the first stroke of the scanning direction, determining deviations for each of the nozzles of each of the printheads based on the determined relative positions of the droplets, ejected by the nozzles of the printheads, and assigning correction factors for printing in the first stroke and for printing in the second opposite stroke to each of the nozzles of the printheads of the plurality of printheads based on the determined deviations of the nozzles of the printheads.

In an embodiment of the system comprising an inkjet printer of the stationary type, wherein the printheads for different printing colours are stationary arranged in a column of the matrix configuration extending in a direction parallel to the conveying direction (C) and the printheads (40) for the same printing colour are arranged in rows extending in a direction perpendicular to the conveying direction (C); wherein a printhead position of a printhead in the matrix configuration is represented by (n, Clr), wherein n indicates the column number of the printheads for printing colour Clr in the matrix configuration and Clr indicates the printing colour in a row of the matrix configuration of the printheads;
the controller is configured for:
printing the test pattern section for each printhead of reference printing colour (Clr_ref) comprising printing at least one line, preferably at least two, such as three spaced apart lines by ejecting ink droplets from each of the nozzles of the printheads for the reference printing colour at position (n, Clr_ref); and/or
printing the test pattern section for each of the printing colours (Clr≠Clr_ref) other than the reference printing colour (Clr_ref) comprising printing at least one line by ejecting ink droplets from each of the nozzles of each of the printheads of the printing colours at printhead positions (n, Clr≠Clr_ref) and printing at least one reference line, preferably at least two reference lines spaced apart by ejecting ink droplets from each of the nozzles of the corresponding printhead for the reference printing colour (Clr_ref) at printhead position (n, Clr_ref) having the same n.

In a third aspect the invention relates to an inkjet printing method of inkjet printing an image on a printing medium, comprising jetting inkjet ink from an inkjet printhead of an inkjet printer having a controller, which jetting is controlled by the controller using corrected control nozzle data derived from correction factors obtained by the method according to the first aspect. The type of printing medium is not restricted. In an embodiment the printing medium is a textile material.

In a fourth aspect the invention relates to a computer program comprising instructions which, when the program is executed by a computing device, cause the computing device to carry out the method according to the first aspect.

The invention is illustrated by means of the attached drawings.

### BRIEF DESCRIPTION OF THE DRAWINGS

FIG. 1 shows a flow diagram of an embodiment of a misalignment correction method according to the invention;

FIG. 2 schematically shows an embodiment of a system of the invention comprising an inkjet printer of the scanning type;

FIG. 3 shows an embodiment of a matrix configuration of printhead arrangement of an inkjet printer of the scanning type.

FIG. 4 schematically shows an embodiment of a test pattern as used in an embodiment of the misalignment correction method according to the invention for an inkjet printer of the scanning type;

FIGS. 5-8 show details of the test pattern according to FIG. 4;

FIG. 9 shows a table summarizing the test pattern sections of FIGS. 5-8 for a reference printing colour and one other printing colour; and

FIG. 10 schematically shows an embodiment of a system of the invention comprising an inkjet printer of the stationary type.

### DETAILED DESCRIPTION OF THE INVENTION

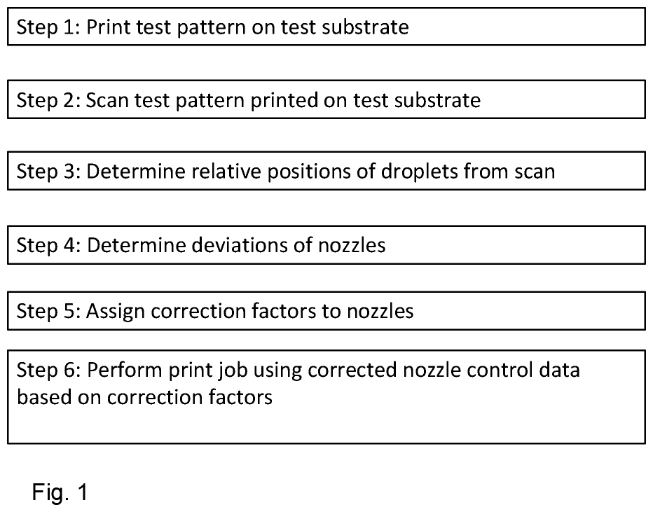

In FIG. 1 a flow diagram of an embodiment of a nozzle misalignment correction method according to the invention, applicable to an inkjet printer of the scanning type and to an inkjet printer of the stationary type is shown. This embodiment comprises a step 1, wherein a test pattern is printed by the nozzles of each printhead of an inkjet printer of the scanning type on a test substrate. The test pattern comprises test pattern sections for each printhead of a printing colour other than the reference printing colour comprising printing elements to be printed by the respective printhead and reference printing elements to be printed by a reference printhead. Typically the printing elements are lines formed by ejecting ink from each of the nozzles of the respective printhead. The design of the test pattern sections for the reference printheads depend on the type of printer as discussed above. The test substrate may have a receiving layer that is compatible with the inkjet ink used. In step 2 the test substrate having the test pattern printed thereon is scanned by a scanner, thereby obtaining a digital scan of the printed test pattern. In step 3 the obtained scan is analysed and the relative position of a printed printing element is determined with respect to a printed reference printing element. From the relative position of the printed printing element the relative deviations of each of the nozzles of the respective printhead are calculated in step 4. To the relative nozzle positions thus determined a correction factor is assigned in step 5 to each nozzle and usually stored in a memory, for example in the form of a chart or table. Typically a correction factor has been rounded to an integer. If desired, a similar line test pattern may be printed using corrected nozzle control data based on the assigned correction factors on a further test substrate having a receiving layer that is compatible with the inkjet ink used, scanned and analysed as a check. In step 6 the inkjet printer performs a printing job of printing an image on a printing medium using corrected nozzle control data based on the assigned correction factors read from the stored chart or table.

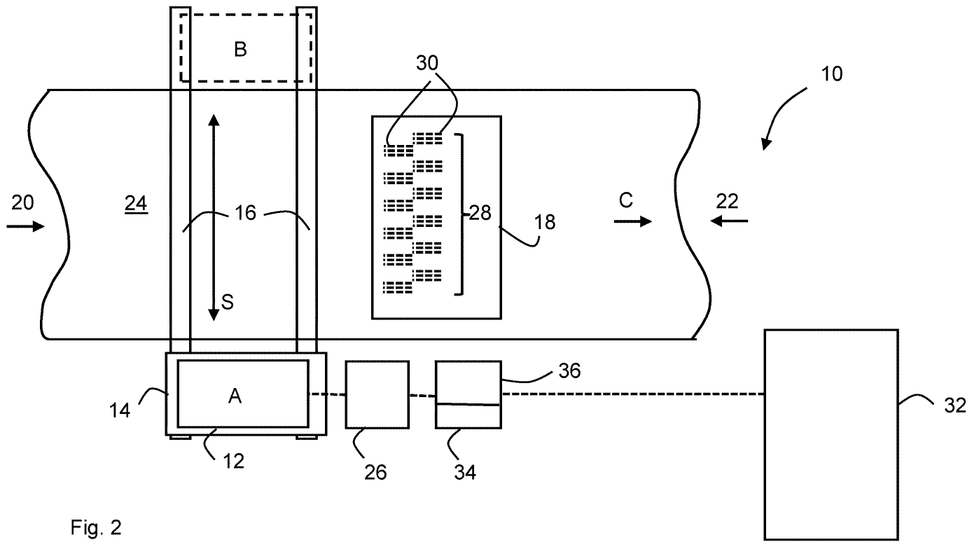

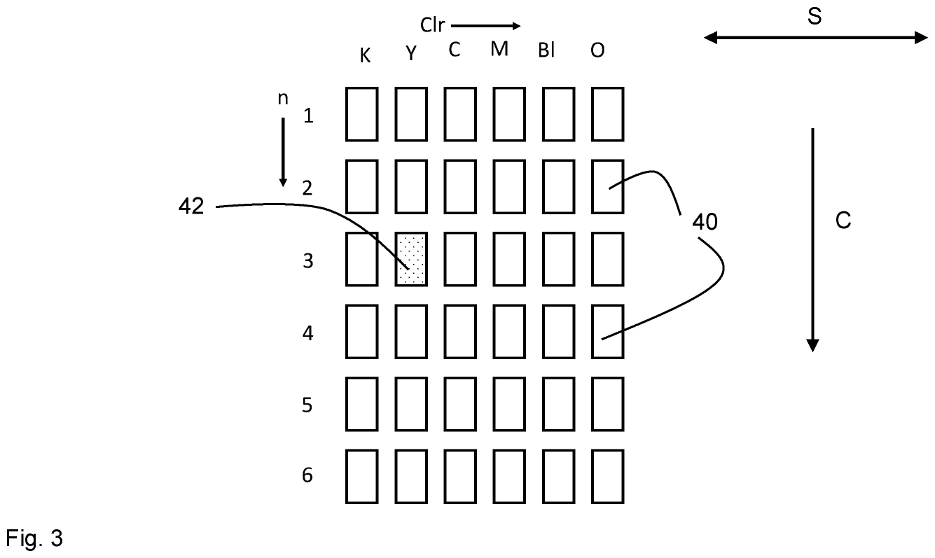

FIG. 2 shows diagrammatically an embodiment of a system for correcting misalignment of printhead nozzles in an inkjet printer of the scanning type. The system 10 comprises an inkjet printer 12, in this case a bidirectional scanning printer wherein the printheads (see FIG. 3) are mounted on a carriage 14, that is reciprocating movably arranged on rails 16 in the width direction (scanning direction; see arrow S) of the test substrate 18, that is intermittently conveyed in a conveyance direction C from an infeed 20 to an outlet 22, e.g. temporarily adhered to a conveyor 24 such as an endless belt. Movement of the carriage 14 in a back-and-forth motion perpendicular to the conveyor direction between positions A and B along the edge of the conveyor 24 and firing by the printheads is controlled by a controller 26, also synchronizing these actions with the movement of the conveyor 24 in order to print a test pattern 28 having test pattern sections 30 on the test substrate 18. A scanner 32 is configured to scan the test substrate 18 that has been printed with the test pattern 28. The digital scan of the test pattern is processed by computer 34 having a processor which is configured to identify relative positions of printing elements and reference printing elements from the digital scan of the test pattern 26, to determine deviations of the printhead nozzles and allocate correction factors to each nozzle. These correction factors are recorded e.g. in a memory 36 of computer 34 and subsequently used by the controller 26 for performing an actual print job.

FIG. 3 shows an embodiment of the printheads 40 of an inkjet printer 12. In the embodiment shown, the printheads are arranged in a matrix configuration of columns representing the printheads of a single printing colour Clr and rows representing the number n of the printhead for a printing colour. The position of a printhead in the matrix configuration is indicated by (Clr, n). In the embodiment shown in FIG. 3, the number of printheads for each printing colour is six (n=6). In this embodiment shown the printing colours are black (K), cyan (C), magenta (M), yellow (Y), blue (Bl) and orange (O). A particular printhead can be identified by its position. The position of the first black printhead is indicated as (K, 1) and the last one as (K, 6). Similar indications are used for the other printing colours. The printheads for one colour are arranged adjacent to one another in the conveyor movement direction C, typically on a print colour bar that is releasably mounted on the carriage. The printheads of differing colours are arranged in the width direction of the conveyor (i.e. in the scanning direction S, perpendicular to the conveyor movement direction C). Each printhead 40 comprises an array of nozzles 42. The (piezo) printhead are configured for jetting ink droplets (typical droplet size e.g. 1-4 picolitres) onto a printing medium conveyed by the conveyor.

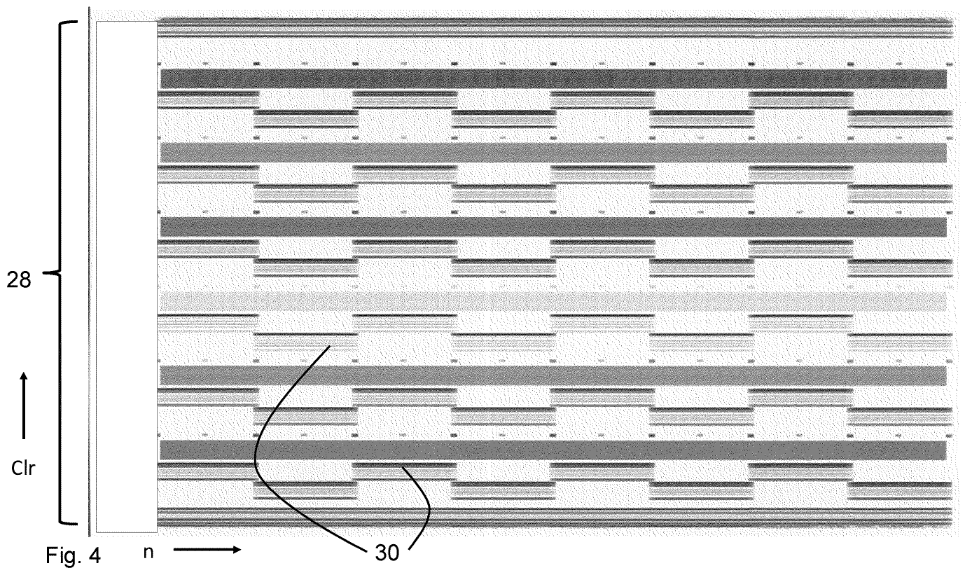

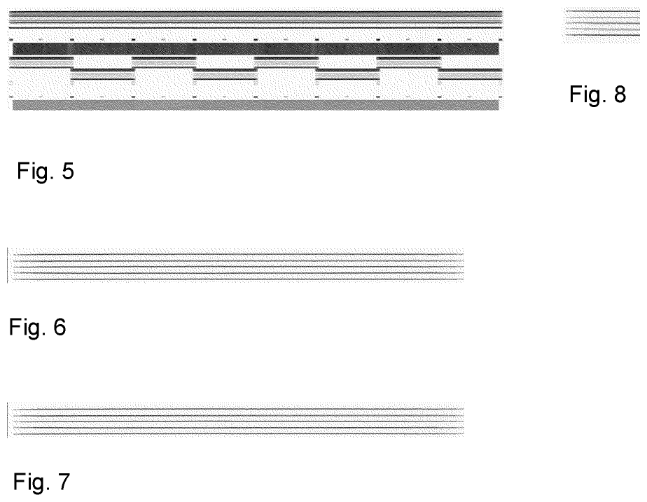

FIG. 4 shows an embodiment of a printed test pattern 28 having test pattern sections 30 for each printhead. In this case there are eight printheads of each printing colour. FIG. 5 shows the printed test pattern sections for the eight black printheads in more detail.

Each test pattern section 30 comprises one or more lines as printing elements printed by ejecting droplets from each of the nozzles of the respective printhead and one or more reference lines as reference printing elements printed by ejecting droplets from each of the nozzles of a reference printhead. A digital scan of the printed test pattern 28 is analysed for misalignment of the nozzles of a printhead. In this embodiment black printhead at position (K, 8) is taken as the reference printhead (Clr_ref=K, r=8). The relative positions and deviations of each of the nozzles of this black reference printhead at position (K, 8) are determined with respect to a reference, for example an imaginary straight line. The relative positions and deviations of each of the nozzles of the other black printheads at positions (K, n=1-7) are determined from one or more lines printed by these other black printheads with respect to reference lines printed in the black reference printhead at position (K, 8). The relative positions and deviations of each of the nozzles of the printheads for the other printing colours (Clr K) at positions (Clr, n=1-8) are determined from one or more lines printed by ejecting droplets of each of the nozzles of these printheads and one or more reference lines printed by the corresponding black printhead in the same row (n is equal).

In an embodiment the test pattern section for the black reference head (K, 8) comprises five parallel spaced apart lines, of which the top three lines and the lower line are printed in the first direction (forward stroke) and the fourth line is printed in the opposite direction (backward stroke). See FIG. 6. The positions of the lines are determined with respect to a reference and the relative positions of each of the nozzles with respect to this reference are measured and the corresponding deviations are measured are calculated therefrom for each individual nozzle.

FIG. 7 shows a printed test pattern section for the remaining black heads (K, n=1-7), wherein seen from top to bottom the first, third and fifth lines are printed by jetting each of the nozzles in a forward stroke of the respective black printhead and the fourth line is printed similarly in the backward stroke. The second line is the reference line printed by the black reference head (K, 8). For each nozzle the relative positions of the lines in the first stroke is determined with respect to the reference line using the equation ((Actual Position Line 1+Actual Position Line 3)/2)−Actual Position Reference Line 2, wherein Actual Position Line 1 and Actual Position Line 3 indicate the positions of the two lines printed by the remaining black printhead and Actual Position Reference Line 2 indicates the position of the reference line printed by the reference black printhead (K, 8). To calculate the relative deviations a spline function is applied to the found relative positions. The deviation for a nozzle of a remaining black printhead in the forward stroke is increased with the deviation calculated for the reference black printhead. For each nozzle the relative position of the lines printed in the backward stroke is determined by the equation Actual Position Line 4 Backward−((Actual Position Line 3+Actual Position Line 5)/2), wherein Actual Position Line 4 Backward indicates the position of the line printed in the backward stroke and Actual Position Line 3 and Actual Position Line 5 indicate the positions of the two neighbouring lines printed by the remaining printhead of the black reference printing colour in the forward stroke. To calculate the relative deviations a spline function is applied to the found relative positions. The deviation for a nozzle of a remaining black printhead in the backward stroke is increased with the deviation calculated for this black printhead in the forward stroke.

FIG. 8 shows a printed test pattern section for the printing colours other than the black reference printing colour (Clr K) at positions (Clr K, n=1-8), wherein—seen from the top to the bottom—the first, third and fifth lines are printed by the printhead of the black reference colour at position (K, n=1-8), the second line is printed in the first stroke direction by ejecting droplets of each of the nozzles of the respective printhead for the respective other colour at position (Clr K, n=1-8) for the same n value, and the fourth line is printed in the opposite stroke direction by ejecting droplets of each of the nozzles of the respective printhead for the respective other colour at position (Clr K, n=1-8) for the same n value. For each nozzle the relative position of a line printed in the forward stroke by the respective printhead for the respective colour other than black can be calculated using the equation Actual Position Line 2−((Actual Position Reference Line 1+Actual Position Reference Line 3)/2), wherein Actual Position Reference Line 1 and Actual Position Reference Line 3 indicate the positions of the two lines printed by the printhead at position (Clr_ref, n) and Actual Position Line 2 indicates the position of the line printed by the black printhead at position (K, n). To determine the relative deviations of the nozzles e.g. a spline function is applied to the relative positions. To these relative deviations the deviations of the printhead of the reference black colour at position (K, n) is added because the position is determined relative to the black printhead at this position). Similarly the deviation of each of the nozzles in the backward stroke can be calculated from the relative positions calculated by the equation Actual Position Line 4−((Actual Position Reference Line 3+Actual Position Reference Line 5)/2), wherein Actual Position Reference Line 3 and Actual Position Reference Line 5 indicate the positions of the two lines printed by the printhead of the black reference colour at position (K, n) and Actual Position Line 4 indicates the position of the line printed by the respective printhead of one of the other printing colours at position (Clr, n) in the backward stroke, to which e.g. a spline function can be applied. To the relative deviations the deviations of the black printhead at position (K, n). are added.

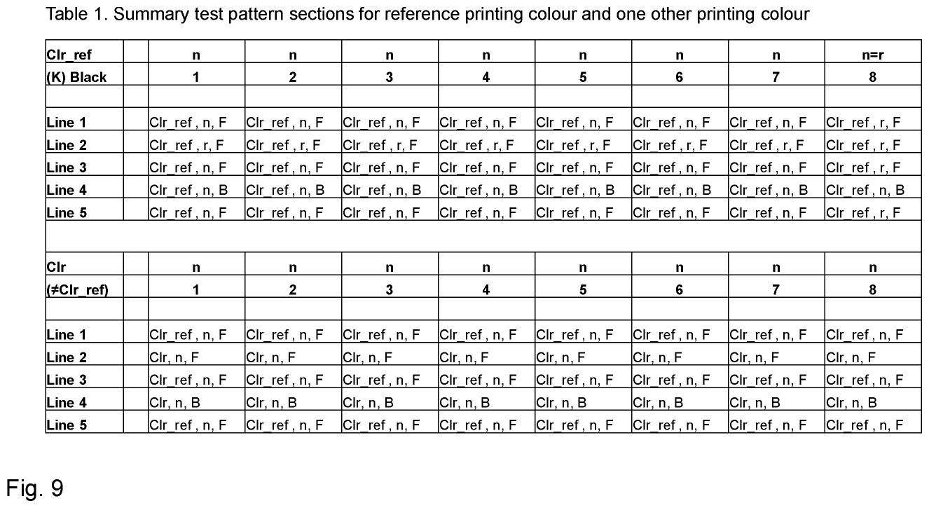

Table 1 shown in FIG. 9 summarizes the above test pattern sections for the eight (n=1-8) printheads of the reference colour (Clr_ref=K (black)) and one of the other printing colours (Clr≠Clr_ref). F indicates that the respective line is printed in a first (forward) stroke of the scanning direction and B indicates that that the respective line is printed in a second (backward) stroke of the scanning direction, opposite to the first stroke.

From the thus determined deviations of each nozzle in the forward stroke and in the backward stroke a correction factor is derived by multiplying with −1 and rounding to an integer. These correction factors for each nozzle of each printhead in the forward stroke and in the backward stroke are stored. The stored correction factors are used in corrected nozzle control data. In the corrected nozzle control data other corrections e.g. non-uniformity/grey scale/oversaturation corrections as known from WO2020239820A1 could also be taken into account.

For other printing speeds, the thus determined correction factor should be corrected. E.g. for a double speed the correction factor should be divided by 2.

### Example

A test pattern as shown in FIG. 4 was printed on a Javelin® inkjet printer (an inkjet printer of the scanning type manufactured by the present applicant using Fujifilm Dimatix® printheads) at a regular speed (1200 dpi; height between nozzle and test substrate 2.8 mm) and the scan of the printed test pattern was analysed to obtain correction factors for each nozzle of the printhead. The example was repeated using corrected nozzle control data based on the correction factors thus determined. The below Table 1 shows the average, median, standard deviation and the range between minimum and maximum deviation based on 2% percentile, for the initial pattern (‘before’) and the pattern printed using the correction factors (‘after’) in the forward stroke and backward stroke.

### Deviation Forward Stroke

| | Before | | | | After | | | |
|---|---|---|---|---|---|---|---|---|
| Color | avg | median | std | Rng(2%) | avg | median | std | Rng(2%) |
| Yellow | 0.466 | 0.352 | 0.6545 | 2.377 | 0.005 | 0.085 | 0.3039 | 1.164 |
| Blue | 0.134 | −0.094 | 0.7716 | 2.665 | 0.049 | 0.048 | 0.2634 | 1.2 |
| Black | −0.565 | −0.615 | 0.4461 | 2.405 | 0.101 | 0.134 | 0.2679 | 1.195 |
| Cyan | −0.43 | −0.352 | 0.6303 | 2.502 | 0.038 | 0.062 | 0.2779 | 1.071 |
| Orange | −1.009 | −0.947 | 0.4091 | 1.84 | 0.021 | 0.052 | 0.3122 | 1.308 |
| Magenta | −0.444 | −0.307 | 0.6017 | 2.654 | 0.013 | −0.061 | 0.3082 | 1.221 |

### Deviation Backward Stroke

| | Before | | | | After | | | |
|---|---|---|---|---|---|---|---|---|
| Color | avg | median | std | Rng(2%) | avg | median | std | Rng(2%) |
| Yellow | 1.231 | 1.193 | 0.9746 | 4.734 | 0.22 | 0.188 | 0.235 | 1.172 |
| Blue | 1.29 | 1.26 | 0.7385 | 3.14 | 0.251 | 0.188 | 0.4344 | 1.885 |
| Black | 1.215 | 1.131 | 0.7278 | 3.539 | 0.133 | 0.15 | 0.3937 | 1.398 |
| Cyan | 1.221 | 1.135 | 0.9019 | 3.754 | 0.206 | 0.285 | 0.3929 | 1.744 |
| Orange | 1.032 | 1.146 | 0.6983 | 2.561 | 0.145 | 0.177 | 0.4073 | 1.663 |
| Magenta | 1.392 | 1.385 | 0.7881 | 3.434 | 0.117 | 0.032 | 0.4757 | 1.724 |

As can be seen, the quality of the image (in this case the test pattern) is significantly improved by printing using the corrected nozzle control data based on the correction factors. Similar results were obtained at fast speed (600 dpi) and at different heights (2.8 and 4.0 mm).

In all examples using corrected nozzle control data also the spread of the deviations was reduced considerably.

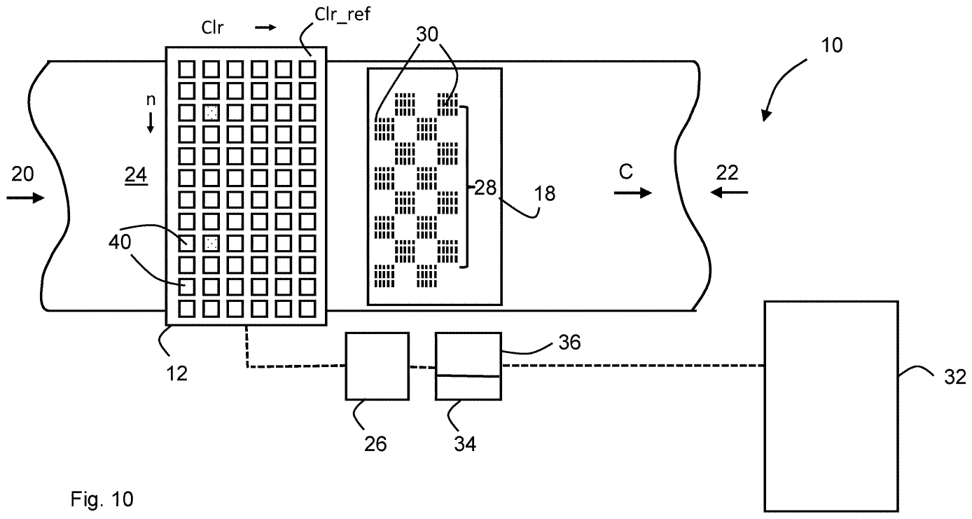

FIG. 10 schematically shows an embodiment of a system of the invention comprising an inkjet printer of the stationary type. In this Fig. a same part as in FIG. 2 bear the same reference numeral. The system 10 comprises an inkjet printer 12 of the stationary type, wherein the printheads 40 are mounted stationary with respect to the conveyor 24, that conveys a printing medium temporarily adhered thereto, in this case a test substrate 18, in a conveyance direction C from an infeed 20 to an outlet 22. Firing by the printheads 40 is controlled by a controller 26, also synchronizing these actions with the movement of the conveyor 24 in order to print a test pattern 28 having test pattern sections 30 on the test substrate 18. A scanner 32 is configured to scan the test substrate 18 that has been printed with the test pattern 28. The digital scan of the test pattern is processed by computer 34 having a processor which is configured to identify relative positions of printing elements and reference printing elements from the digital scan of the test pattern 26, to determine deviations of the printhead nozzles and allocate individual correction factors to each nozzle. These correction factors are recorded e.g. in a memory 36 of computer 34 and subsequently used by the controller 26 for performing an actual print job. In this type of inkjet printer 12 the printheads 40 (number of which is indicated by n) of a certain colour Clr, typically mounted on a printing colour bar that is releasably mounted in a frame bridging the conveyor, are arranged in the width direction of the conveyor, thus perpendicular to the conveying direction C. The series of printheads 40 for different printing colours are positioned in the conveying direction as indicated by the arrow. Typically black is the last colour to print.

1.-19. (canceled)

20. A method of correcting misalignment of nozzles of a multi-colour inkjet printer for printing an image on a printing medium that is movable with respect to the inkjet printer in a conveying direction, the inkjet printer having a plurality of printheads for each printing colour, the plurality of printheads being mounted in a matrix configuration of columns and rows, a printhead having an array of nozzles configured for ejecting ink droplets of a printing colour, wherein either the printheads of the same printing colour are arranged in a column of the matrix configuration extending in a direction parallel to the conveying direction and the printheads for different printing colours are arranged in rows extending in a direction perpendicular to the conveying direction on a carriage that can reciprocate in a scanning direction perpendicular to the conveying direction of the printing medium, or the printheads for different printing colours are stationary arranged in a column of the matrix configuration extending in a direction parallel to the conveying direction and the printheads for the same printing colour are arranged in rows extending in a direction perpendicular to the conveying direction;
wherein the method comprises the steps a)-b) of:
printing a test pattern on a test substrate, the test pattern comprising a test pattern section for each printhead;
scanning the printed test pattern thereby obtaining a scan of the printed test pattern;
a) analysing the scan for relative positions of droplets, ejected by each of the nozzles of each of the printheads for a reference printing colour, Clr_ref, with respect to a reference element;
b) analysing the scan for relative positions of droplets, ejected by each of the nozzles of each of the printheads for each of the printing colours, Clr≠Clr_ref, other than the reference printing colour, Clr_ref, with respect to relative positions of the droplets ejected by each of the nozzles of the corresponding printhead for the reference printing colour, Clr_ref;
c) determining deviations for each of the nozzles of each of the printheads based on the determined relative positions of the droplets, ejected by the nozzles of the printheads, by applying a mathematical function defined piecewise by polynomials; and
d) assigning correction factors to each of the nozzles of each of the printheads of the plurality of printheads based on the determined deviations of the nozzles of the printheads.

21. The method according to claim 20, wherein the printheads of the same printing colour are arranged in a column of the matrix configuration extending in a direction parallel to the conveying direction and the printheads for different printing colours are arranged in rows extending in a direction perpendicular to the conveying direction on a carriage that can reciprocate in a scanning direction perpendicular to the conveying direction of the printing medium, wherein a printhead position of a printhead in the matrix configuration is represented by Clr, n, wherein Clr indicates the printing colour in a column of the matrix configuration of the printheads, and n indicates the row number of the printheads for colour Clr in the matrix configuration;
wherein step a) comprises the substeps of:
a1) determining relative positions of droplets, ejected by each of the nozzles of a reference printhead for a reference printing colour, Clr_ref, at printhead position (Clr_ref, r), with respect to a reference element,
a2) determining relative positions of droplets, ejected by each of the nozzles of the remaining printheads for the reference printing colour, Clr_ref, at printhead position (Clr_ref, n r) with respect to relative positions of droplets ejected by the nozzles of the reference printhead for the reference printing colour at printhead position (Clr_ref, r).

22. The method according to claim 21, wherein printing the test pattern section for the reference printhead of reference printing colour, Clr_ref, comprises during movement of the carriage in a first stroke of the scanning direction printing at least one line by ejecting ink droplets from each of the nozzles of the reference printhead for the reference printing colour at position (Clr_ref, r).

23. The method according to claim 21, wherein printing the test pattern section for each of the remaining printheads of reference colour, Clr_ref, comprises during movement of the carriage in a first stroke of the scanning direction printing at least one line by ejecting ink droplets from each of the nozzles of each of the remaining printheads of the reference printing colour at printhead positions (Clr_ref, n≠r) and printing at least one reference line by ejecting ink droplets from the nozzles of the reference printhead for the reference printing colour at printhead position (Clr_ref, r).

24. The method according to claim 21, wherein printing the test pattern section for each of the printing colours, Clr≠Clr_ref, other than the reference printing colour, Clr_ref, comprises during movement of the carriage in a first stroke of the scanning direction printing at least one line by ejecting ink droplets from each of the nozzles of each of the printheads of the printing colours at printhead positions (Clr≠Clr_ref, n) and printing at least one reference line by ejecting ink droplets from the nozzles of the corresponding printhead for the reference printing colour, Clr_ref, at printhead position (Clr_ref, n) having the same n.

25. The method according to claim 21, wherein the inkjet printer is of the bidirectional scanning type and wherein printing of the test pattern further comprises during movement of the carriage in a second stroke in the scanning direction opposite to the first stroke printing at least one line for each printing colour by ejecting ink droplets from each of the nozzles of each printhead of the plurality of printheads at position (Clr, n), further comprising determining relative positions of the droplets ejected by each of the nozzles of each of the printheads for each of the printing colours at position (Clr, n) during movement of the carriage in a second stroke in the scanning direction opposite to the first stroke, with respect to relative positions of the droplets ejected by each of the nozzles of the corresponding print head for the reference printing colour, Clr_ref, at printhead position (Clr_ref, n) having the same n during the movement of the carriage in the first stroke of the scanning direction, determining deviations for each of the nozzles of each of the printheads based on the determined relative positions of the droplets, ejected by each of the nozzles of the printheads, and assigning correction factors for printing in the first stroke and for printing in the second opposite stroke to each of the nozzles of the printheads of the plurality of printheads based on the determined deviations of the nozzles of the printheads.

26. The method according to claim 20, wherein the printheads for different printing colours are stationary arranged in a column of the matrix configuration extending in a direction parallel to the conveying direction and the printheads for the same printing colour are arranged in rows extending in a direction perpendicular to the conveying direction; wherein a printhead position of a printhead in the matrix configuration is represented by (n, Clr), wherein n indicates the column number of the printheads for printing colour Clr in the matrix configuration and Clr indicates the printing colour in a row of the matrix configuration of the printheads;
wherein step a) comprises:
determining relative positions of droplets, ejected by each of the nozzles of each of the printheads for a reference printing colour, Clr_ref, at position (n, Clr_ref) with respect to a reference element.

27. The method according to claim 21, wherein a line of a printing colour, Clr≠Clr_ref, other than the reference printing colour, Clr_ref, from which line the relative positions of the droplets are determined, is printed spaced apart between lines of the reference printing colour, Clr_ref.

28. The method according to claim 26, wherein printing of the test pattern sections for the printheads of each printing colour at printhead position (n, Clr), wherein n is the same for each printing colour, comprises printing spaced apart at least two lines of each printing colour, Clr≠Clr_ref, other than the reference printing colour, Clr_ref, from which lines the relative positions of the droplets are determined, and printing at least one line of the reference printing colour, Clr_ref, between the at least one line of each printing colour, Clr≠Clr_ref, other than the reference printing colour, Clr_ref, and at least one line of the reference printing colour, Clr_ref, in front of the first line of the first printed printing colour, Clr≠Clr_ref, other than the reference printing colour, Clr_ref and at least one line of the reference printing colour, Clr_ref, at the rear of the last line of the last printed printing colour, Clr≠Clr_ref, other than the reference printing colour, Clr_ref.

29. The method according to claim 20, wherein the reference printing colour, Clr_ref is black.

30. The method according to claim 20, wherein the correction factors are integers representing a translation in pixels.

31. The method according to claim 20, wherein the test substrate is a rigid, preferably white, plastic film having a receiving layer adapted to the nature of the inkjet ink.

32. A system for correcting misalignment of nozzles of a multi-colour inkjet printer for printing an image on a printing medium that is movable with respect to the inkjet printer in a conveying direction, comprising
an inkjet printer having a plurality of printheads for each printing colour, the plurality of printheads being mounted in a matrix configuration of columns and rows, a printhead having an array of nozzles configured for ejecting ink droplets of a printing colour, wherein either the printheads of the same printing colour are arranged in a column of the matrix configuration extending parallel to the conveying direction, and the printheads for different printing colours are arranged in rows of the matrix configuration on a carriage that can reciprocate in a scanning direction perpendicular to the conveying direction of the printing medium; wherein a position of a printhead in the matrix configuration is represented by (Clr, n) wherein Clr indicates the printing colour, and n indicates the row number of the printhead for colour Clr in the matrix configuration, or the printheads for different printing colours are stationary arranged in a column of the matrix configuration extending in a direction parallel to the conveying direction and the printheads for the same printing colour are arranged in rows extending in a direction perpendicular to the conveying direction, wherein a printhead position of a printhead in the matrix configuration is represented by (n, Clr), wherein n indicates the column number of the printheads for printing colour Clr in the matrix configuration and Clr indicates the printing colour in a row of the matrix configuration of the printheads; the inkjet printer being provided with a controller configured for controlling the nozzles of the plurality of inkjet printheads;
a scanner for scanning a test pattern printed by the inkjet printer; and
a computer configured to correct misalignment of nozzles of the plurality of printheads of the inkjet printer according to the method of claim 20 resulting in corrected nozzle control data for the controller; based on the assigned correction factors.

33. The system according to claim 32, further comprising a test substrate having a receiving layer adapted to the nature of the inkjet ink.

34. The system according to claim 32, further comprising a memory readable by the controller and configured for storing the correction factors of each nozzle of the plurality of printheads.

35. The system according to claim 32, wherein the controller is configured to print a test pattern on the test substrate by jetting inkjet ink from an inkjet printhead of the inkjet printer and configured to print an image on a printing medium by jetting inkjet ink from an inkjet printhead of the inkjet printer using the corrected nozzle control data.

36. An inkjet printing method of inkjet printing an image on a printing medium, comprising jetting inkjet ink from an inkjet printhead of an inkjet printer having a controller, which jetting is controlled by the controller using corrected control nozzle data based on correction factors obtained by the method according to claim 20.

37. A computer program comprising instructions which, when the program is executed by a computing device, cause the computing device to carry out the method according to claim 20 using a multi-colour inkjet printer and scanner.
